(19) United States
(12) Patent Application Publication
(10) Pub. No.: US 2026/0207421 A1
(43) Pub. Date: Jul. 23, 2026

(54) ROCKER ARM-TYPE VIBRATION GENERATING DEVICE AND VIBRATION MASSAGE DEVICE

(71) Applicant: LONGNAN PINXIN MOTOR CO., LTD., LONGNAN (CN)

(72) Inventor: GUANXI LAI, GANZHOU (CN)

(73) Assignee: LONGNAN PINXIN MOTOR CO., LTD., LONGNAN (CN)

(21) Appl. No.: 19/343,060

(22) Filed: Sep. 29, 2025

(30) Foreign Application Priority Data
Jan. 23, 2025 (CN) 2025201627042
Aug. 25, 2025 (CN) 2025218144650

(51) Int. Cl. A61H 19/00; A61H 23/02

(52) U.S. Cl. CPC A61H 19/44; A61H 23/0254; A61H 2201/1215; A61H 2201/1436

(57) ABSTRACT

A rocker arm-type vibration generating device and a vibration massage device are provided. The rocker arm-type vibration generating device includes: a drive motor, and a rocker arm assembly provided with a driven portion, a driving portion, and a rocker arm joint; a linkage assembly provided with a driving end and a responding end; and a support assembly provided with a first end and a second end. The drive motor is connected to the driving end, and the driven portion is connected to the responding end. The first end is connected to the rocker arm joint to support and form a fulcrum of the rocker arm assembly. An axis L1 extends from the second end to the first end, and an axis L2 extends from the rocker arm joint to the driving portion. The first end, the second end, and the driving portion are configured to transmit vibration energy outward.

### CROSS-REFERENCE OF RELATED APPLICATION

The present application claims priorities of Chinese Patent Application No. 202520162704.2, filed on Jan. 23, 2025, and Chinese Patent Application No. 202521814465.0, filed on Aug. 25, 2025, the contents of which are incorporated herein by reference in their entirety.

### TECHNICAL FIELD

The present disclosure relates to the technical field of massagers, and in particular to a rocker arm-type vibration generating device and a vibration massage device.

### BACKGROUND

With the popularization of massage equipment such as fascia guns and massagers, vibration massage has become the most common functional mode. Currently, each of most of these products generates the vibration mainly in a way of driving an eccentric counterweight through a rotary motor. To enhance a vibration intensity, it is usually necessary to increase the drive motor power or increase a weight and eccentric distance of the counterweight, which essentially relies on increasing a centrifugal force to achieve a stronger vibration effect. However, a high-frequency, small-amplitude vibration generated in this way tends to cause perceptual numbness and decreased local sensitivity of a target massage area within a short time (about 1 minute, varying slightly, depending on the specific massage area) when applied to the human body of a user.

During massage, it is necessary to stimulate the target massage area until reaching an excitation threshold to achieve effective relaxation or relief. Once the local perceptual capability is weakened, the difficulty of reaching the excitation threshold increases, and actual massage effect and user experience are compromised. Therefore, vibration generation methods in the prior art exhibit obvious limitations in terms of human ergonomics, and there is a need for vibration generating device that balances the stimulation intensity and perceptual adaptability.

### SUMMARY

To solve the above problems in the prior art, the present disclosure provides a rocker arm-type vibration generating device provided with a drive motor, including:
a rocker arm assembly provided with a driven portion, a driving portion, and a rocker arm joint;
a linkage assembly provided with a driving end and a responding end; and
a support assembly provided with a first end and a second end;
where the drive motor is connected to the driving end;
where the driven portion is connected to the responding end;
where the first end is connected to the rocker arm joint to support and form a fulcrum of the rocker arm assembly;
where an axis L1 extends from the second end to the first end, and an axis L2 extends from the rocker arm joint to the driving portion;
the axis L1 and the axis L2 are not parallel to each other;
where the linkage assembly is configured to convert a rotational motion of the driving end to a swinging and/or rotational motion of the axis L2 relative to the axis L1 in a linked manner;
where the first end is connected to a first vibration load; and/or
the second end is connected to a second vibration load; and/or
the driving portion is connected to a third vibration load; and
where the first end, the second end, and the driving portion are configured to transmit vibration energy outward.

Further, the third vibration load is a counterweight.

Further, the driving portion performs a circumferential rotational motion around the axis L1.

Further, the axis L2 performs a swinging motion with the rocker arm joint as a center of a circle.

Further, the rocker arm joint is provided with a first protrusion, the first protrusion forms a spherical structure, the first end is provided with a first connection hole, an axis of the first connection hole is collinear with the axis L1, and an inner wall surface of the first connection hole has a spherical structure; and
the spherical structure of the first protrusion, and the spherical structure of the first connection hole form a spherical fit.

Further, the first end is provided with a flexible cover plate, and the flexible cover plate is provided with a second connection hole;
the rocker arm joint is provided with two first axial limiting portions, and the two first axial limiting portions are respectively located at both ends of the flexible cover plate in a thickness direction, to restrict an axial displacement between the rocker arm assembly and the flexible cover plate; and
flexible deformation of the flexible cover plate permits swinging of the rocker arm assembly.

Further, the support assembly has a cylindrical structure, the first end is one end of the cylindrical structure, and the first end is connected to the rocker arm assembly through a flexible strip; and
flexible deformation of the flexible strip permits swinging of the rocker arm assembly.

Further, the driving portion performs an elliptical motion around the axis L1.

Further, a waist-shaped hole is formed in the first end, and a length direction of the waist-shaped hole is perpendicular to the axis L1; and the rocker arm joint is provided with a second protrusion, and a circumferential wall surface of the second protrusion and an inner wall surface of the waist-shaped hole are provided with spherical surfaces coupled to each other.

Further, the first end is provided with a first sliding groove, a sliding direction is perpendicular to the axis L1, and a first sliding block is installed in the first sliding groove; and
the rocker arm joint is connected to the first sliding block, and the first sliding block forms the fulcrum.

Further, the rocker arm joint is provided with a third protrusion, the third protrusion forms a spherical structure, the first sliding block is provided with a third connection hole, an axis of the third connection hole is parallel to the axis L1, and an inner wall surface of the third connection hole has a spherical structure; and
the spherical structure of the third protrusion, and the spherical structure of the third connection hole form a spherical fit.

Further, the responding end abuts against the driven portion in a rotation direction, and the driven portion is pushed to move in a rotation direction of the drive motor;
the responding end rotates relative to the rocker arm assembly; and
the abutment of the responding end against the driven portion enables the rocker arm assembly to maintain a fixed swinging angle.

Further, the driving portion is provided with a protective sleeve; and
the protective sleeve is sleeved outside the driving portion to isolate the driving portion from a flexible layer of a massager; and
the protective sleeve freely rotates relative to the driving portion.

Further, the support assembly is fixedly connected to the drive motor.

Further, the drive motor is flexibly connected to the driving end, and
is directly or indirectly flexibly connected to the support assembly.

Further, a torque of the drive motor is transmitted to the driving end through a flexible shaft, and the flexible shaft may be bent.

Further, the drive motor is flexibly connected to the support assembly through an elastic member, and the elastic member allows the support assembly to move relative to the drive motor; and
the elastic member supports the flexible layer of the massager.

Further, the driving end is rotatably connected to the support assembly.

Further, an included angle between the axis L1 and the axis L2 is denoted as a, and a degree of the included angle a ranges from 5° to 30°.

Further, a vibration massage device is provided with the rocking arm-type vibration generating device according to any one of claims, including:
a cylindrical elastic massage sleeve provided with an inner cavity;
where the rocker arm-type vibration generating device is disposed in the inner cavity; and
where the swinging and/or rotational motion of the axis L2 relative to the axis L1 may cause periodic bending deformation of the cylindrical elastic massage sleeve.

The beneficial effects of the present disclosure are manifested in that during the motion of the rocker arm assembly of the present disclosure, both the driving portion and the driven portion generate a centrifugal force, and vibrations are generated at both ends of the driving portion and the driven portion, where the vibrations at both ends have a large amplitude due to no loss during vibration transmission. In the present disclosure, vibrations are generated at both ends of the fulcrum, the vibrations at both ends of the fulcrum converge toward the fulcrum, and energy of the two vibrations superimposes at the fulcrum, which to a certain extent, makes up for the energy consumed when energy of a single vibration is transmitted to the fulcrum. Therefore, the vibration generating device maintains a relatively consistent vibration amplitude along its entire length, and an amplitude of vibration in this area basically approaches a maximum amplitude of vibration that the device transmits. Thus, the vibration massage device of the present disclosure ensures a large amplitude of vibration in a large massage region.

### BRIEF DESCRIPTION OF THE DRAWINGS

FIG. 1 is a three-dimensional structural schematic diagram of a rocker arm-type vibration generating device provided by the present disclosure (swinging motion).

FIG. 2 is a sectional schematic diagram of a rocker arm-type vibration generating device (swinging motion).

FIG. 3 is a three-dimensional schematic diagram of a driven portion and a responding end of a rocker arm-type vibration generating device (swinging motion).

FIG. 4 is a three-dimensional structural schematic diagram of a rocker arm-type vibration generating device provided by the present disclosure (circumferential rotational motion).

FIG. 5 is a three-dimensional structural schematic diagram of a rocker arm-type vibration generating device provided by the present disclosure (circumferential rotational motion I).

FIG. 6 is a sectional structural schematic diagram of a first end and a rocker arm joint of a rocker arm-type vibration generating device (circumferential rotational motion I).

FIG. 7 is an exploded sectional structural schematic diagram of a first end and a rocker arm joint of a rocker arm-type vibration generating device (circumferential rotational motion I).

FIG. 8 is a sectional structural schematic diagram of a first end and a rocker arm joint of a rocker arm-type vibration generating device (circumferential rotational motion II).

FIG. 9 is a sectional structural schematic diagram of a first end and a rocker arm joint of a rocker arm-type vibration generating device (Example 1 of circumferential rotational motion III).

FIG. 10 is a sectional structural schematic diagram of a first end and a rocker arm joint of a rocker arm-type vibration generating device (Example 2 of circumferential rotational motion III).

FIG. 11 is a three-dimensional structural schematic diagram of a first end and a rocker arm joint of a rocker arm-type vibration generating device (circumferential rotational motion IV).

FIG. 12 is a three-dimensional structural schematic diagram of a rocker arm-type vibration generating device (elliptical rotational motion I).

FIG. 13 is an exploded three-dimensional structural schematic diagram of a rocker arm-type vibration generating device (elliptical rotational motion I).

FIG. 14 is a front view of the rocker arm-type vibration generating device in FIG. 12.

FIG. 15 is a three-dimensional structural schematic diagram of a rocker arm-type vibration generating device (elliptical rotational motion II).

FIG. 16 is a sectional view of the rocker arm-type vibration generating device in FIG. 15.

FIG. 17 is a schematic diagram of connection between a responding end and a driven portion of a rocker arm-type vibration generating device (circumferential rotational motion II).

FIG. 18 is a schematic diagram of connection between a responding end and a driven portion of a rocker arm-type vibration generating device (circumferential rotational motion III).

FIG. 19 is a schematic diagram of vibration diffusion in a rocker arm-type vibration generating device.

FIG. 20 is a sectional structural schematic diagram of a rocker arm-type vibration generating device in Embodiment 4 of the present disclosure (a drive motor is located behind a support assembly).

FIG. 21 is a sectional structural schematic diagram of a rocker arm-type vibration generating device in Embodiment 4 of the present disclosure (a drive motor is located on a side of a support assembly).

FIG. 22 is a vibration massage device provided by the present disclosure.

Reference numerals in the figures: 1—drive motor; 11—flexible shaft; 2—rocker arm assembly; 21—driven portion; 22—driving portion; 221—protective sleeve; 23—rocker arm joint; 231—first protrusion; 232—second protrusion; 233—third protrusion; 234—fourth protrusion; 235—first axial limiting portion; 3—linkage assembly; 31—driving end; 32—responding end; 4—support assembly; 41—first end; 411—first connection hole; 412—flexible cover plate; 4121—second connection hole; 413—flexible strip; 414—waist-shaped hole; 415—first sliding groove; 416—first sliding block; 4161—third connection hole; 417—fourth connection hole; 4171—second axial limiting portion; 42—second end; 43—elastic member; 51—first vibration load; 52—second vibration load; 53—third vibration load; and 6—cylindrical elastic massage sleeve.

### DETAILED DESCRIPTION OF PREFERRED EMBODIMENTS

In order to The technical solutions in the embodiments of the present disclosure will be clearly and completely described below in combination with the accompanying drawings in the embodiments of the present disclosure. Apparently, the embodiments described are merely some rather than all of the embodiments of the present disclosure. Based on the embodiments of the present disclosure, all other embodiments obtained by those of ordinary skill in the art without making creative efforts shall fall within the protection scope of the present disclosure.

### Embodiment 1

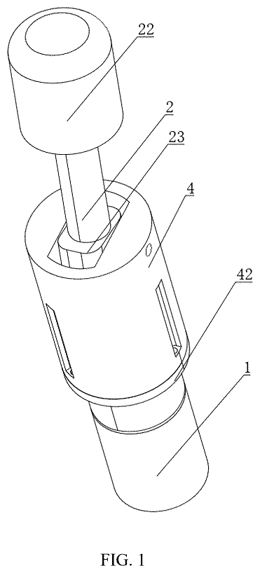

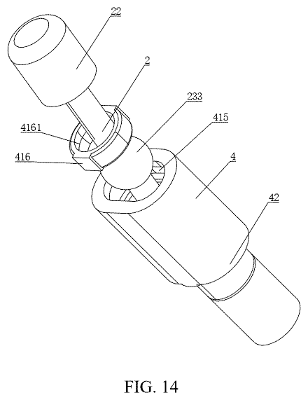

Please refer to FIGS. 1 to 22.

A rocker arm-type vibration generating device is provided with a drive motor 1 and includes:
a rocker arm assembly 2 provided with a driven portion 21, a driving portion 22, and a rocker arm joint 23;
a linkage assembly 3 provided with a driving end 31 and a responding end 32;
a support assembly 4 provided with a first end 41 and a second end 42;
where the drive motor 1 is connected to the driving end 31;
where the driven portion 21 is connected to the responding end 32;
where the first end 41 is connected to the rocker arm joint 23 to support and form a fulcrum of the rocker arm assembly 2;
where an axis L1 extends from the second end 42 to the first end 41, and an axis L2 extends from the rocker arm joint 23 to the driving portion 22;
the axis L1 and the axis L2 are not parallel to each other;
where the linkage assembly 3 is configured to convert a rotational motion of the driving end 31 to a swinging and/or rotational motion of the axis L2 relative to the axis L1 in a linked manner;
where the first end 41 is connected to a first vibration load 51;
where the second end 42 is connected to a second vibration load 52;
where the driving portion 22 is connected to a third vibration load 53; and
where the first end 41, the second end 42, and the driving portion 22 are configured to transmit vibration energy outward.

A rocker arm-type vibration generating device is provided in this embodiment. First, a drive motor 1 is included, and the drive motor only provides rotational power.

A rocker arm assembly 2 and a support assembly 4 are further included.

The rocker arm assembly 2 at least includes a driven portion 21, a driving portion 22, and a rocker arm joint 23; and the support assembly 4 includes a first end 41 and a second end 42.

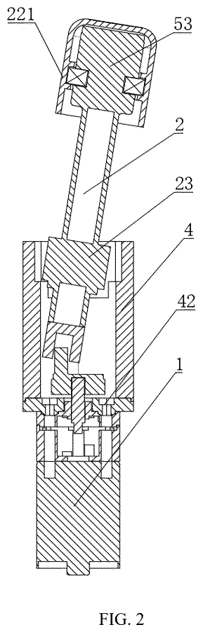

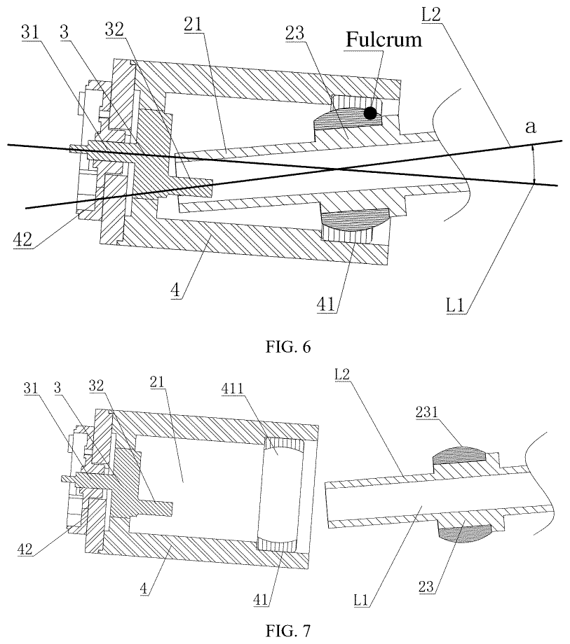

From the perspective of swinging motion, the rocker arm assembly 2 is defined as a rod hinged to the support assembly 4 for reciprocating swinging, as shown in FIGS. 1 and 2; and alternatively, the rocker arm assembly 2 is defined as a rod inclined to a rotation axis that rotates with a point on the rotation axis as a fulcrum, as shown in FIGS. 6 to 10.

The support assembly 4 is a component that provides a fulcrum for the rocker arm assembly 2, the support assembly 4 is provided with at least two connection portions, namely the first end 41 and the second end 42, and the first end 41 is connected to the rocker arm joint 23 to support and form a fulcrum of the rocker arm assembly 2 and is connected to the first vibration load 51, where the first vibration load 51 refers to a structure capable of generating resistance for the motion of the support assembly 4; and
that is, the first vibration load 51 restricts the motion of the first end 41, and the first end 41 restricts the motion of the rocker arm assembly 2, as shown in FIG. 22, where the first vibration load 51 may be a flexible sleeve or a rigid shell wrapping a position of the first end 41 of the support assembly 4. With reference to FIG. 22, the second end 42 is connected to the second vibration load 52, the support assembly 4 has a certain length, the support assembly 4 may be understood as a cylindrical structure, and two ends of the cylindrical structure are the first end 41 and the second end 42 respectively, where the first end 41 is provided with a hole, the hole is connected to the rocker arm joint 23 to provide a fulcrum for the rocker arm assembly 2, and then the flexible sleeve may directly wrap an outer circular wall surface of the cylindrical structure, that is, the first end 41 is connected to the first vibration load 51, and the second end 42 is also connected to the second vibration load 52.

An axis L1 extends from the second end 42 to the first end 41, and an axis L2 extends from the rocker arm joint 23 to the driving portion 22;
the axis L1 is an axis formed by the support assembly 4, the support assembly 4 may be a bracket or sleeve of various shapes, the axis L1 is formed between a position where the support assembly 4 is connected to the rocker arm joint 23 and a position where the support assembly is connected to the second vibration load 52, that is, the axis L1 is formed between the first end 41 and the second end 42; and
the axis L2 is an axis extending from the rocker arm joint 23 to the driving portion 22 in the rocker arm assembly 2. There is no special requirement for an extending direction of the driven portion 21 and the rocker arm joint 23, and the driven portion 21, through cooperation between the drive motor 1 and the linkage assembly 3, causes the axis L2 to swing or rotate relative to the axis L1.

With reference to FIGS. 1 to 3, swinging means that when the axis L2 swings, a rotation axis perpendicular to and passing through the axis L1 is formed at a position of the fulcrum, and the axis L2 swings back and forth on both sides of the axis L1 around the rotation axis.

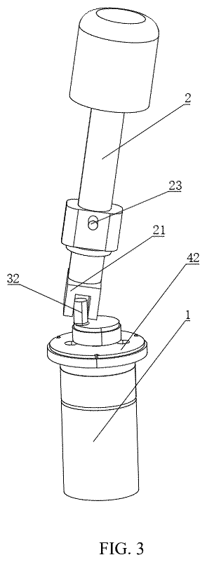

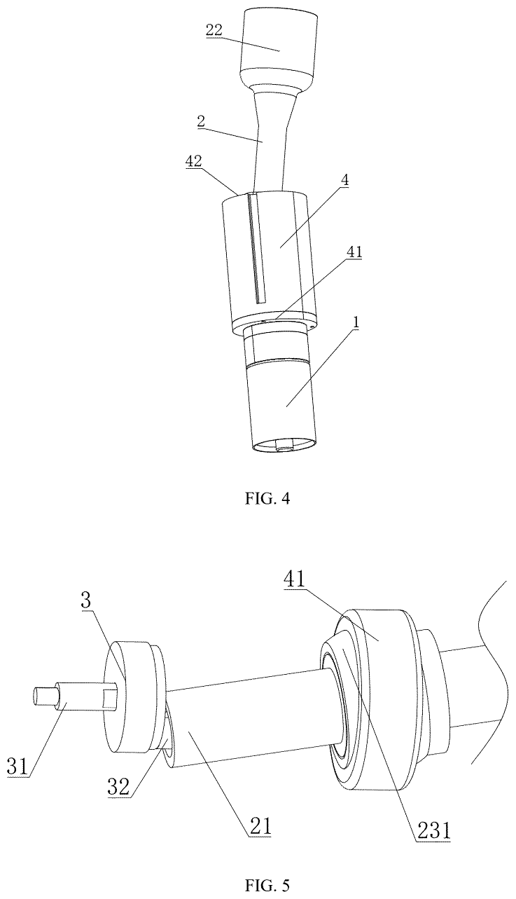

With reference to FIGS. 4 to 11, rotation means that the axis L2 and the axis L1 are not parallel to but intersect each other, when the axis L2 rotates, a rotation vertex is formed at an intersection (that is, a position where the first end 41 and the rocker arm joint 23 are connected) between the axis L2 and the axis L1, and a conical shape is formed along a motion path of the axis L2.

The driven portion 21 in the rocker arm assembly 2 of the present disclosure refers to a portion connected to the drive motor 1, and the driven portion 21 receives rotational power of the drive motor 1.

When the rocker arm assembly 2 performs the above swinging motion, the drive motor 1 drives the driven portion 21 to perform a reciprocating motion along an arc path around the rotation axis; and when the rocker arm assembly 2 performs the above rotational motion, the drive motor 1 needs to drive the driven portion 21 to perform a circumferential rotational motion around an axis of the drive motor 1. The rotational motion mentioned herein may be a circumferential rotational motion or an elliptical rotational motion.

The rocker arm assembly 2 may perform horizontal swinging or rotational motion, and the rotational motion may be the circumferential rotational motion or the elliptical rotational motion. A transmission structure (the driven portion 21 and the linkage assembly 3) and a connection structure (the first end 41 and the rocker arm joint 23) corresponding to the rocker arm assembly 2 vary for the above three motion forms, while other components and connection methods are completely the same.

### I. Swinging Motion

A vibration generated by a reciprocating swinging motion form is mainly concentrated on both sides perpendicular to a swinging axis, while a vibration amplitude at both ends of the swinging axis is relatively small, which is suitable for massage that requires the concentrated vibration, where the massage is specific to a target massage point. A corresponding structure is as follows:
1. As shown in FIGS. 2 and 3, the first end 41 is provided with a shaft, and the rocker arm joint 23 is provided with a hole structure; or the first end 41 is provided with a hole, and the rocker arm joint 23 is provided with a protruding shaft, and the first end and the rocker arm joint are hinged, where a hinge axis is perpendicular to the axis L1.

### II. Rotational Motion

A vibration generated by the circumferential rotational motion diffuses around the axis of the drive motor 1, so a uniform vibration effect is formed in a circumferential direction of the entire rocker arm-type vibration generating device, which is suitable for a cylindrical massager; when the massager is inserted into the human body for massage, a uniform massage effect on a target massage area around the massager is generated, without need to consider the directionality of the massager; and when using, a user may rotate the massager such that massage textures on an exterior of the massager generate a rotating massage effect on the target massage area, without impairment to the vibration massage effect. For the swinging motion, the driving portion 22 cannot participate in a vibration output when swinging back toward the axis L1, and the drive motor 1 needs to actively overcome inertia to swing the driving portion 22 back to the other side thereof; however, for the circumferential rotational motion, the driving portion 22 always keeps a same distance from the axis L, and a motion direction during the rotational motion remains unchanged; and the drive motor 1 does not need to resist the inertia of the driving portion 22 during motion, and therefore, the rocker arm-type vibration generating device with the rotational motion form is easier to achieve the vibration effect through a small-volume drive motor 1. A corresponding structure is as follows:

First, as shown in FIGS. 5 and 6, the first end 41 is provided with a first connection hole 411, a wall surface of the first connection hole 411 is spherical, a center of the first connection hole 411 is located in L1, the rocker arm joint 23 forms a first protrusion 231 in a radial direction of the rocker arm assembly 2, a circumferential wall surface of the first protrusion 231 is spherical, and a spherical fit is formed between the first connection hole 411 and the first protrusion 231. When an inner wall of the first connection hole 411 is a convex spherical surface, and the circumferential wall surface of the first protrusion 231 is a concave annular spherical surface; and when an inner wall surface of the first connection hole 411 is a concave spherical surface, the circumferential wall surface of the first protrusion 231 is a convex spherical surface. Under the condition of the spherical fit, the rocker arm assembly 2 rotates around a center of the sphere, and any point on the wall surface of the first connection hole 411 that participates in support is a fulcrum.

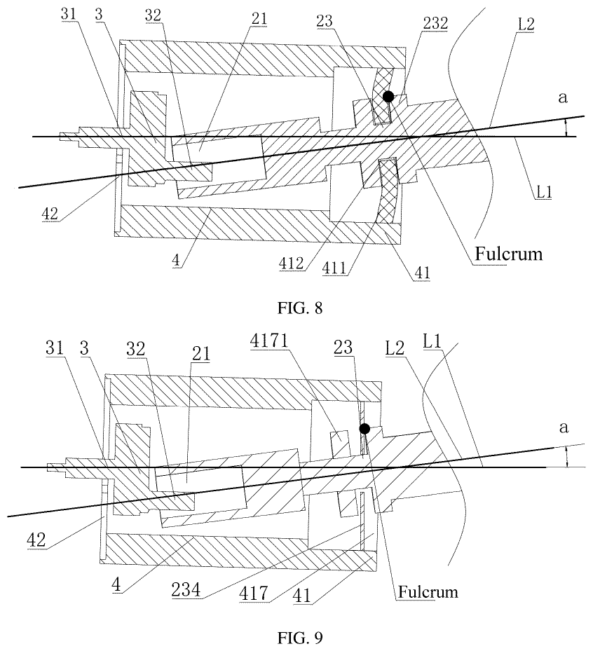

Second, with reference to FIGS. 7 and 8, the first end 41 may be provided with a flexible cover plate 412 (made of rubber, silicone, or the like) and a second connection hole 4121, a main body of the support assembly 4 is cylindrical, and the flexible cover plate 412 is connected to a front end of the support assembly 4, where the rocker arm assembly 2 passes through the second connection hole 4121 of the flexible cover plate 412, and in this case, an edge of the second connection hole 4121 through which the rocker arm assembly 2 passes through the flexible cover plate 412 is a fulcrum, and when the rocker arm assembly 2 swings, the flexible cover plate 412 is deformed under compression, and the fulcrum changes to provide clearance for the swinging of the rocker arm assembly 2. The rocker arm joint 23 may be directly adhesively bonded to the flexible cover plate 412, or two first axial limiting portions 235 may be formed in a way of protruding in the radial direction of the rocker arm assembly 2, where the flexible cover plate 412 is located between the two first axial limiting portions 235, and the first axial limiting portions 235 prevent the rocker arm joint 23 and the flexible cover plate 412 from sliding.

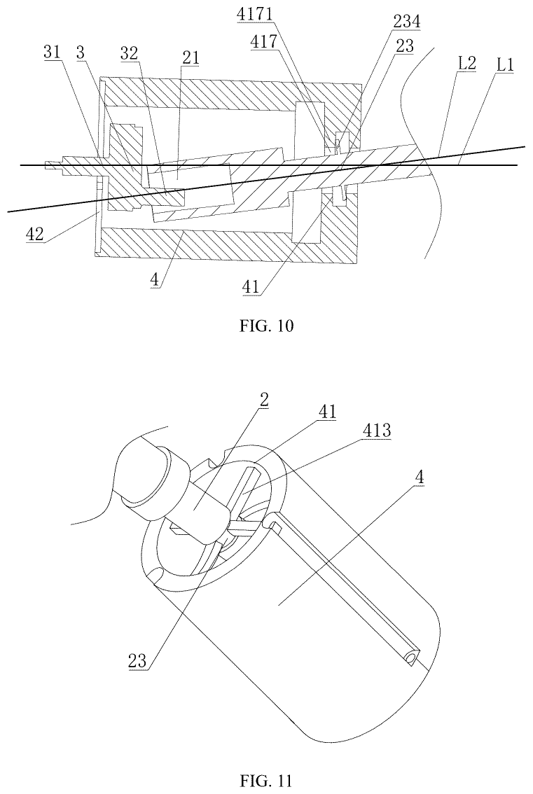

Third, with reference to FIGS. 9 and 10, the first end 4 is provided with a fourth connection hole 417, and an inner wall surface of the fourth connection hole 417 and a circumferential wall surface of the rocker arm joint 23 are provided with a second axial limiting portion 4171 and a fourth protrusion 234 respectively, where at least two second axial limiting portions 4171 are arranged, and the two second axial limiting portions 4171 are respectively located on both sides of the fourth protrusion 234 in a direction of the axis L1; and the second axial limiting portions 4171 limit a sliding distance of the rocker arm assembly 2 along the axis L1 and enable the rocker arm assembly 2 to swing.

Example 1: With reference to FIG. 9, a circular recess is formed around an inner circumferential wall surface of the fourth connection hole 417, the second axial limiting portions 4171 are disposed at two ends of the recess, and a circular boss protrudes from the rocker arm joint 23 in the radial direction thereof, where the circular boss is the fourth protrusion 234, and the fourth protrusion 234 is disposed between the two second axial limiting portions 4171. It should be noted that a thickness of the fourth protrusion 234 is less than a spacing between the two second axial limiting portions 4171, and a diameter of the fourth connection hole 417 is greater than a diameter of the rocker arm joint 23 (the rocker arm joint 23 is not necessarily a cylinder, and the diameter mentioned herein refers to a diameter of a circumcircle formed along an edge of the rocker arm joint 23) to ensure that the rocker arm assembly 2 has a certain tilting space.

Example 2: With reference to FIG. 10, the inner wall surface of the fourth connection hole 417 protrudes from the fourth protrusion 234, two second axial limiting portions 4171 are formed on the circumferential wall surface of the rocker arm joint 23, and the fourth protrusion 234 is still disposed between the two second axial limiting portions 4171.

Fourth, with reference to FIG. 11, the support assembly 4 still has a cylindrical structure, the first end 41 is one end of the cylindrical structure, and then an outer circular wall surface of the rocker arm assembly 2 and an inner circular wall surface of the cylindrical structure are directly connected by a few flexible strips 413, where the first end 41 is located at an intersection between the flexible strip 413 and the support assembly 4, and the rocker arm joint 23 is located at an intersection between the flexible strip 413 and the rocker arm assembly 2 (in this case, the first end 41 and the rocker arm joint 23 do not need additional structures, but only specific positions are required). For example, four rubber flexible strips 413 are arranged, the four rubber flexible strips 413 are distributed in a cross shape, one end of each of the rubber flexible strips 413 is connected to an inner wall surface of the support assembly 4, and the other end thereof is connected to the rocker arm joint 23; and when the rocker arm assembly 2 swings toward one of the rubber flexible strips 413, a position where the rubber flexible strip opposite to this rubber flexible strip is connected to the rocker arm joint 23 serves as a fulcrum for the swinging of the rocker arm assembly 2, and a front end and a rear end of the rocker arm assembly 2 swing in opposite directions.

### III. Elliptical Rotational Motion

A vibration generated by the elliptical rotational motion is actually a combination of vibrations caused by the above reciprocating swinging and rotational motion, that is, the vibration effect in a long axis direction of an elliptical motion trajectory is stronger than the vibration effect from the rotational motion, and the vibration effect in a short axis direction thereof is stronger than the vibration effect on both sides of a swinging axis for the swinging motion. The vibration caused by the rotational motion has no directionality and is uniformly transmitted to the surrounding; although the target massage area may wrap the massager, and the sensitivity at different positions on an inner wall of the target massage area varies, where there are sensitive points at a top and bottom of a channel of the target massage area, and therefore, the vibration energy may be mainly concentrated on an upper top portion and a lower bottom portion of the channel of the target massage area, that is, the long axis of the elliptical motion trajectory points to the upper top portion and the lower bottom portion. A short axis of the elliptical motion trajectory points to left and right sides of the channel of the target massage area, such that a sufficient vibration is felt on both sides of the target massage area.

A structure of the elliptical rotational motion is actually a further improvement made to a structure of the circular rotation. A corresponding structure is as follows:

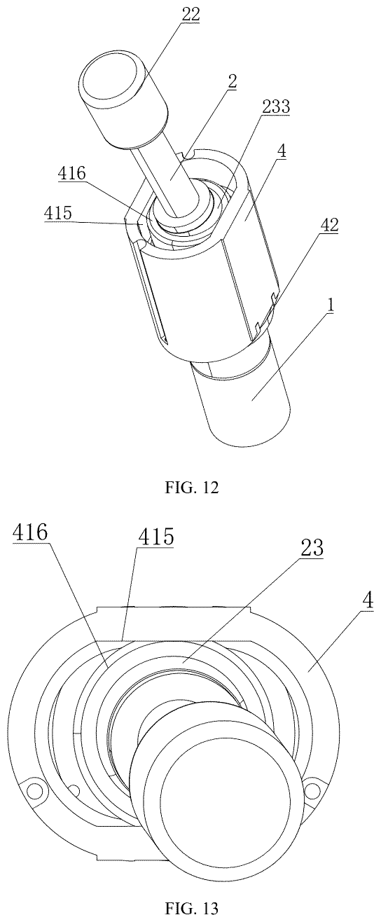

First, with reference to FIGS. 12 to 14, the first end 41 is provided with a first sliding groove 415, a first sliding block 416 is installed in the first sliding groove 415, a sliding direction is perpendicular to the axis L1, a third connection hole 4161 is formed in the first sliding block 416, an inner wall surface of the third connection hole 4161 has a spherical structure, the rocker arm joint 23 is provided with a third protrusion 233, and the third protrusion 233 forms a spherical structure; and the third protrusion 233 is nested in the third connection hole 4161 to form a spherical fit so as to achieve the rotational motion, and the first sliding block 416 drives the rocker arm joint 23 to slide along the first sliding groove 415, such that an original circular trajectory is elongated to form an elliptical trajectory.

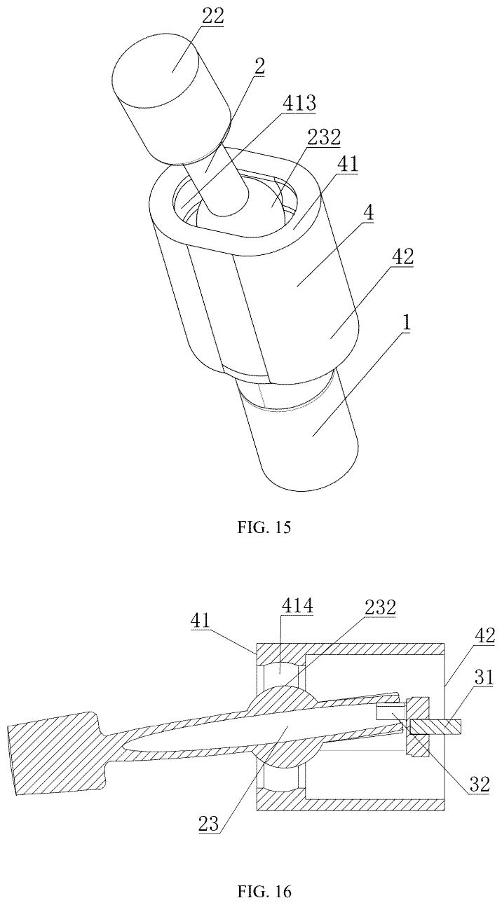

Second, with reference to FIGS. 15 and 16, a waist-shaped hole 414 is formed in the first end 41, and then the rocker arm assembly 2 is inserted into the waist-shaped hole 414, where an inner wall surface of the waist-shaped hole 414 is spherical, the rocker arm joint 23 is provided with a second protrusion 232, a circumferential wall surface of the second protrusion 232 is spherical, and spherical surfaces of the waist-shaped hole 414 and the second protrusion 232 are coupled to each other. When the spherical surface of the waist-shaped hole 414 is concave, the spherical surface of the second protrusion 232 is convex; and correspondingly, when the spherical surface of the waist-shaped hole 414 is convex, the spherical surface of the second protrusion 232 is concave. The spherical fit provides a center point for the rotation of the rocker arm assembly 2, the waist-shaped hole 414 has a specific length, and the rocker arm assembly 2 also slides during rotation, thereby elongating a circular rotation trajectory to form an elliptical trajectory.

Further, the drive motor 1 only provides a rotational driving force, and the rocker arm assembly 2 moves in multiple forms, such that the drive motor 1 hardly directly drives motion of the driven portion 21. Therefore, the device of the present disclosure further includes a linkage assembly 3, and the linkage assembly 3 includes a driving end 31 and a responding end 32. The driving end 31 only needs to be connected to an output shaft of the drive motor 1, and for example, the driving end 31 is provided with a hole, and the output shaft of the drive motor 1 is directly inserted into the hole of the driving end 31 for fixing.

The responding end 32 has a plurality of structural forms, and a structure of the responding end 32 varies when the rocker arm assembly 2 performs different motions.

### I. A Structure Corresponding to the Swinging Motion

1. The driven portion 21 is provided with a recess, and two side wall surfaces of the recess are respectively located in a reciprocating direction of swinging. The responding end 32 rotates around the axis L1 (which may be achieved by connecting the linkage assembly 3 to the support assembly 4 through a gear shift, or the axis of the drive motor 1 is coaxially arranged with the axis L1, and the linkage assembly 3 is directly fixed in the output shaft of the drive motor 1), and the responding end 32 is configured as an eccentric protrusion, where the eccentric protrusion is eccentric relative to the axis L1, the eccentric protrusion is inserted into the recess of the driven portion 21 and abuts against the side wall surface of the recess, and when the eccentric protrusion rotates, a direction deviating from L1 changes, such that the eccentric protrusion abuts against and pushes the side wall surface of the recess to swing the rocker arm assembly 2.

### II. A Structure Corresponding to the Rotational Motion

During the rotational motion of the rocker arm assembly 2, the driven portion 21 may be a simple rod, one end of the simple rod is fixedly connected to the rocker arm joint 23, and the other end thereof serves as a matching end, where the matching end is matched with the responding end 32, and the responding end 32 only needs to push the matching end to rotate around the axis L1. To meet this requirement of pushing the matching end to rotate around the axis L1, it is necessary to at least ensure that the responding end 32 abuts against the driven portion 21 in a rotation direction; the responding end 32 rotates relative to the rocker arm assembly 2; and the abutment of the responding end 32 against the driven portion 21 enables the rocker arm assembly 2 to maintain a fixed swinging angle. Specifically, details are as follows:

First, with reference to FIGS. 5 to 10, the linkage assembly 3 is a connecting plate, the output shaft of the drive motor 1 is perpendicular to a plate surface of the connecting plate and fixed to the linkage assembly 3, an edge of the connecting plate is provided with a recess or hole as the responding end 32, the matching end of the driven portion 21 is inserted into the responding end 32, the drive motor 1 drives the entire connecting plate to rotate, and then a wall surface of the recess or hole pushes the matching end to rotate around the axis L1.

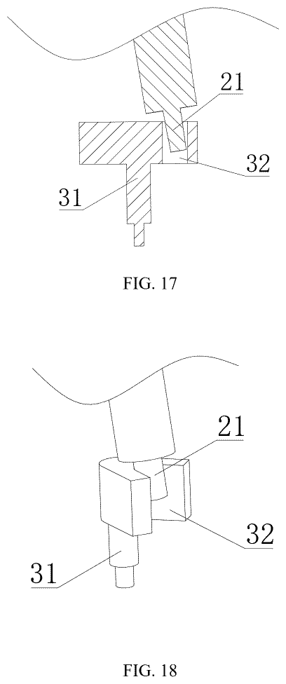

Second, with reference to FIG. 17, correspondingly, the matching end of the driven portion 21 may also be provided with a recess or hole, and the connecting plate is provided with a protruding rod as the responding end 32, where the responding end 32 is inserted into the recess or hole of the matching end, which also achieves the rotation of the matching end around the axis L1.

Third, with reference to FIG. 18, the responding end 32 has a V-shaped structure, the driven portion 21 is configured as a rod, the driven portion 21 is inserted into an opening of the V-shaped structure, a main shaft of the drive motor 1 is connected to an intersection of the V-shaped structure to drive the entire V-shaped structure to rotate, and a wall surface of the opening of the V-shaped structure pushes the driven portion 21 to rotate.

Further, the first end 41 is connected to the first vibration load 51; and/or
the second end 42 is connected to a second vibration load 52; and/or
the driving portion 22 is connected to a third vibration load 53; and

A vibration is relative, e.g., when the driving portion 22 rotates or swings, the vibration is generated relative to the support assembly 4, so the support assembly 4 must have a certain resistance; for example, when a user directly holds the support assembly 4 using fingers, if resistance to the support assembly 4 is generated only at one position, the entire vibration generating device is likely to swing, thus requiring at least one more position to connect a load; hence, the first end 41 and the second end 42 of the support assembly 4 are connected to the first vibration load 51 and the second vibration load 52 respectively; the second end 42 has no specific positional requirement, that is, the second end may be located at any position of the support assembly 4, and optimally, the second end 42 is one end of the support assembly 4 farthest from the first end 41; and the second vibration load 52 may also be understood as a resistance from a housing or silicone sleeve of the massager, and additionally, the drive motor 1 may also be fixedly connected to the support assembly 4, where a load on the second end 42 may be generated based on a weight of the drive motor.

The driving portion 22 is connected to the third vibration load 53, the driving portion 22, i.e., an end portion of the rocker arm assembly 2, may be connected to a counterweight as the third vibration load 53, or connected to any external component capable of blocking the motion of the third vibration load 53. The counterweight as the third vibration load 53 may be an ordinary metal mass block or a mass block with other functions, such as a heating module formed by winding a resistance wire around the metal block. Any motion is relative, the drive motor drives a shaft to rotate, but in fact, when the shaft of the drive motor is fixed, the drive motor drives the housing to rotate. In the present disclosure, the rocker arm assembly 2 may be understood as the shaft of the above motor, such that when the driving portion 22 is fixed, the support assembly 4 swings. Therefore, the above first vibration load 51, the second vibration load 52, or the third vibration load 53 is actually a resistance that prevents the motion of various components, but the device needs to generate vibration and cannot be completely fixed, and therefore, a way of connecting the load is adopted to generate resistance to the motion of the device, which does not completely restrict an offset of the vibration.

A rocker arm-type vibration generating device capable of the circumferential rotational motion is taken an example to compare with a drive motor of the prior art; and

The drive motor of the prior art includes the drive motor 1 and an eccentric counterweight, and the eccentric counterweight performs a circumferential rotational motion around the output shaft of the drive motor 1; and usually, a housing of the drive motor 1 is fixed, and it may be envisioned that a vibration amplitude of the drive motor near an eccentric vibration block is the largest, and the vibration is transmitted in a conical manner. After the drive motor is connected to the housing of the massager, an amplitude of vibration received by the housing of the massager is further reduced, and therefore, the massager provided with the drive motor of the prior art with the same specification as that of the drive motor 1 is more likely to make the user feel numb, mainly because the amplitude of vibration transmitted is small. Additionally, in a massager provided with the drive motor of the prior art, intensities of vibrations in a vibration function area are not uniform, and a better vibration effect is mainly concentrated at a position near the eccentric counterweight.

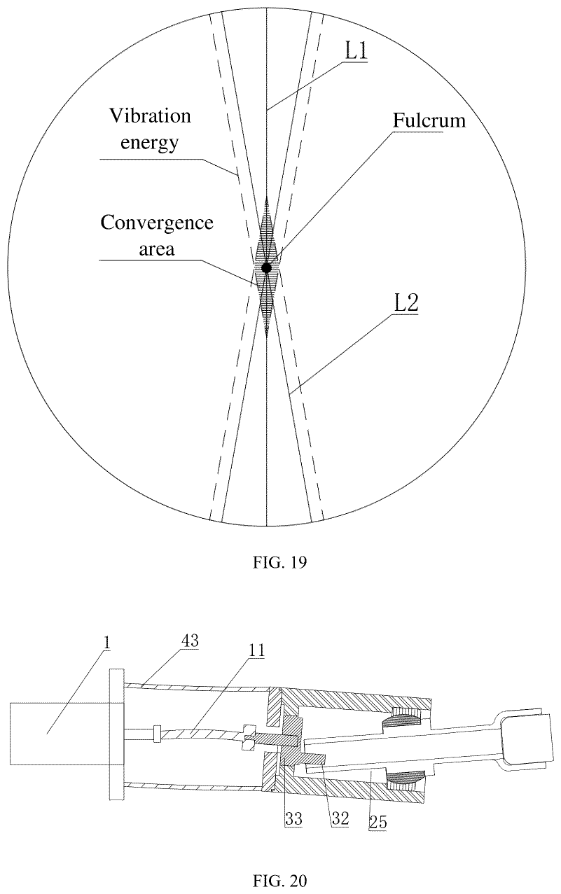

The rocker arm-type vibration generating device of the present disclosure achieves an effect of large-range and uniform vibrations, and the vibration amplitude is superior to that of the drive motor of the prior art, such that the user of the massager hardly feels numb and the vibration massage coverage is expanded. Specific details are as follows: When the vibration generating device of the present disclosure rotates, both ends of the vibration generating device, i.e., the driving portion 22 and the driven portion 21, are involved in the motion deviating from the axis L1; a line between the rocker arm joint 23 and a force-bearing point of the driven portion 21 is denoted as L3; both L2 and L3 are inclined relative to L1; and as shown in FIG. 19, after rotation, L2 and L3 form a double-cone shape with the rocker arm joint 23 as a vertex (after the swinging motion, a double triangular shape the rocker arm joint 23 as the vertex is formed). Both the driving portion 22 and the driven portion 21 are equivalent to eccentric blocks of the drive motor in the prior art, the driving portion 22 and the driven portion 21 are located on both sides of the rocker arm joint 23 respectively, and the rocker arm joint 23 is connected to the first end 41, such that centrifugal forces are generated at both ends of the rocker arm joint 23; the support assembly 4 supports the rocker arm joint 23 at a fulcrum, and an original centrifugal force gets smaller when approaching the fulcrum, while the vibration effect diminishes; and however, in the present disclosure, vibrations are generated at both ends of the fulcrum, the vibrations at both ends of the fulcrum converge toward the fulcrum, and energy of the two vibrations superimposes at the fulcrum, which to a certain extent, makes up for the energy consumed when energy of a single vibration is transmitted to the fulcrum. Therefore, the vibration generating device maintains a relatively consistent vibration amplitude along its entire length, and an amplitude of vibration in the area where the vibrations at both ends of the fulcrum converge toward basically approaches a maximum amplitude of vibration that the device transmits (the maximum amplitude of vibration that the device transmits refers to an amplitude of near the driving end 31, which is equivalent to an amplitude of vibration at the eccentric counterweight of the prior art). Thus, the vibration massage device of the present disclosure ensures a large amplitude of vibration in a large massage region, and the large range ensures that sensitive points in the massage region are completely covered; and this massage region fully covers the target massage area, and an amplitude of vibration in this massage region remains large, which effectively prevents local numbness of the massage area.

Further, with reference to FIGS. 6-9 and 19, an included angle between the axis L1 and the axis L2 is denoted as a, a degree of the included angle a ranges from 5° to 30°, and the degree of the included angle a should not be too large; after the axis L2 rotates or swings, an included angle formed by the axis L2 on both sides of a motion path is twice the included angle a, where a maximum degree of the included angle a is 30°; and when the included angle a gets smaller, more vibration energy converges toward the vertex, thereby preventing the vibration energy of the driving portion 22 from being much greater than the vibration energy at the vertex, and resulting in an uneven distribution of vibration amplitudes, where a shaded area in FIG. 19 is an area where the vibration energy on both sides of the fulcrum converges.

### Embodiment 2

With reference to FIG. 2, the driving portion 22 is provided with a main body and a protective sleeve 221; and
the protective sleeve 221 is sleeved outside the main body, and the protective sleeve 221 may rotate freely relative to the main body.

The rocker arm-type vibration generating device of the present disclosure is used in a massager. The driving portion 22 rubs against an inner wall of a flexible layer of the massager for a long time during rotation, and the flexible layer is easily damaged during long-term friction. To reduce friction, a lubricating medium is usually added, but a friction path is a circular ring, and a relative position between the driving portion 22 and the flexible layer changes continuously, such that it is difficult for the lubricating medium to remain in the friction path. Thus, the protective sleeve 221 is added to the driving portion 22 in this embodiment. The protective sleeve 221 is sleeved outside the driving portion 22, an outer wall surface of the protective sleeve 221 is in direct contact with the flexible layer of the massager, the inner wall surface of the protective sleeve 221 is rotatably connected to the driving portion 22, and a bearing may be arranged between the protective sleeve 221 and the driving portion 22 to ensure smoother rotation of them. The driving portion 22 is indirectly in contact with the flexible layer through the protective sleeve 221, and conversion of an original sliding friction into a rolling friction greatly reduces a friction force, which effectively prevents the driving portion 22 from damaging the flexible layer, and the vibration effect at the driving portion 22 is still effectively transmitted to an exterior of the massager through the indirect contact between the driving portion 22 and the flexible layer. When the third vibration load 53 is a counterweight, the protective sleeve 221 needs to wrap the third vibration load 53, that is, the driving portion 22 is only allowed to come into contact with the flexible layer indirectly through the protective sleeve 221.

### Embodiment 3

Please refer to FIGS. 1 to 18.

The support assembly 4 may be directly fixedly connected to the drive motor 1. For example, when the support assembly 4 has a cylindrical structure, two ends of the support assembly 4 are the first end 41 and the second end 42 respectively. The first end 41 is connected to the rocker arm joint 23, and the second end 42 is connected to the drive motor 1, and in this case, the weight of the drive motor 1 may directly serve as the second vibration load 52.

### Embodiment 4

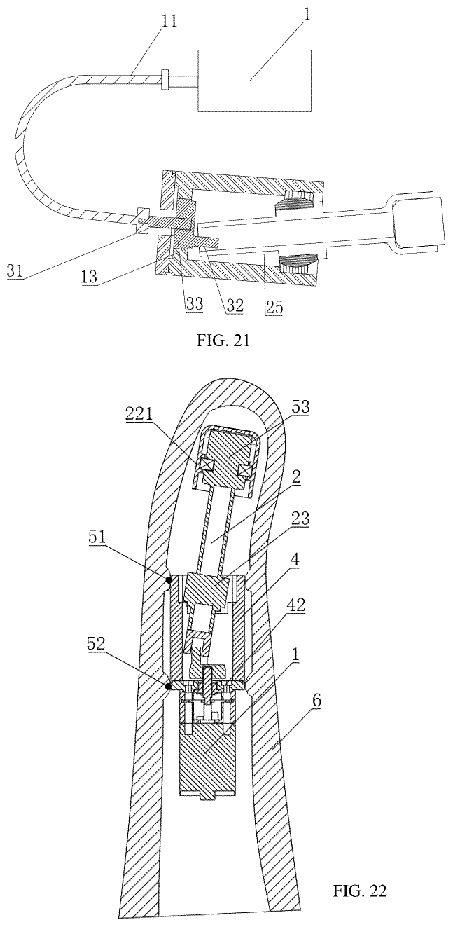

Please refer to FIGS. 20 to 21.

Further, the drive motor 1 is flexibly connected to the driving end 31, and is directly or indirectly flexibly connected to the support assembly 4.

The output shaft of the drive motor 1 may be connected to the driving end 31 through a flexible shaft 11, the flexible shaft 11 needs to have sufficient anti-rotation strength to ensure that a torque of the drive motor 1 is transmitted to the driving end 31, and the flexible shaft 11 has a low bending resistance.

In the entire massager, the drive motor 1 must be fixed, but is not necessarily fixed in the support assembly 4, the drive motor 1 may also be fixed in the housing of the massager, and then the drive motor 1 is flexibly connected to the driving end 31, that is, the driving end 31 and the drive motor 1 may be relatively displaced (the displacement mentioned herein mainly refers to an offset generated during vibration); and further, direct connection between the drive motor 1 and the support assembly 4 is no longer needed. For example, the flexible layer of the massager directly wraps the support assembly 4 and the drive motor 1, and the drive motor 1 is not rigidly connected to the support assembly 4, but connected through the flexible layer of the massager of the present disclosure. Further, with reference to FIG. 20, the flexible layer of the massager needs to be in direct contact with the human body, so the material is limited, and a too soft flexible layer is most likely to change a basic shape of the massager; an elastic member 43 may be added between the support assembly 4 and the drive motor 1 to maintain the basic shape of the massager without completely restricting the degree of freedom of the support assembly 4; the support assembly 4 does not keep static due to the fixing of the drive motor 1; and in this case, a better vibration transmission effect is achieved with enhanced rigidity of components, and a flexible connection structure of the drive motor 1 blocks the transmission of vibration, such that the drive motor 1 may be almost free of vibration, and the drive motor 1 is fixedly connected to the housing of a gripping portion of the massager, thereby ensuring that the user's hand is free from numbness caused by the vibration. The elastic member 43 may be configured as a large-diameter spring, two ends of the spring are connected to the support assembly 4 and the drive motor 1, and a circumferential wall surface of the spring supports the flexible layer of the massager. Alternatively, the elastic member 43 is configured as an elastically bendable rod, and a plurality of the elastic members 43 are arranged and distributed around the flexible shaft 11 to support the flexible layer of the massager.

Additionally, the second end 42 of the support assembly 4 no longer needs to be connected to the drive motor 1, the second end 42 may be directly connected to the flexible layer, and an elastic force of the flexible layer serves as the second vibration load 52 (the second vibration load 52 further includes elastic forces of the flexible shaft 11 and the elastic member 43). When power of the drive motor 1 remains unchanged, an increase in the load makes it more difficult to increase a vibration amplitude, the drive motor 1 is the heaviest component in the entire rocker arm-type vibration generating device, and in this embodiment, the drive motor 1 does not participate in vibration, which greatly reduces a weight of the second vibration load 52, such that the device of the present disclosure may easily increase the vibration amplitude; and as shown in FIG. 21, the drive motor 1 is connected to the driving end 31 through the flexible shaft 11, and the flexible shaft 11 transmits a torque in a bent state, such that the drive motor 1 is installed in a more free manner; and when a length of a target vibration area of the massager is not enough to accommodate the rocker arm-type vibration generating device together with the drive motor 1, the flexible shaft 11 may be bent, and then the drive motor 1 is installed on a side of the support assembly 4, such that the rocker arm-type vibration generating device of the present disclosure may be adapted to more types of vibration massagers.

Further, the linkage assembly 3 is rotatably connected to the support assembly 4. Easy bending of the flexible shaft 11 causes instability of connection with the linkage assembly 3, thereby resulting in shaking of the linkage assembly 3 and a friction between the linkage assembly 3 and the inner wall of the flexible layer; and therefore, the linkage assembly 3 and the support assembly 4 are rotatably connected to each other, and for example, the support assembly 4 is configured to have a cylindrical structure, a main body of the linkage assembly 3 is configured to have a disc structure, a circumferential wall surface of the disc structure is rotatably connected to the inner wall surface of the support assembly 4, and the flexible shaft 11 is connected to an axis position of the disc structure, where a connection position serves as the driving end 31.

### Embodiment 5

Please refer to FIGS. 1 to 22.

A vibration massage device using the rocker arm-type vibration generating device of the present disclosure is provided in this embodiment.

The vibration massage device includes a cylindrical elastic massage sleeve 6 provided with an inner cavity;
where the rocker arm-type vibration generating device is disposed in the inner cavity; and
where the swinging and/or rotational motion of the axis L2 relative to the axis L1 may cause periodic bending deformation of the cylindrical elastic massage sleeve 6.

In the vibration massager in the prior art, the drive motor is wrapped very tightly, the vibration is transmitted to the human body through the flexible layer of the massager, and enhanced rigidity of the components ensures tighter connection with the drive motor and also better vibration transmission; and therefore, the flexible layer wrapping the drive motor in the prior art is relatively thick, thereby achieving a tough and elastic state, and the flexible layer wrapping the drive motor does not deform during massage.

The cylindrical elastic massage sleeve 6 in this embodiment has a small elastic coefficient and easily bends, and after the rocker arm-type vibration generating device is activated, the vibration energy may cause deformation of the cylindrical elastic massage sleeve 6. A main offset direction of the vibration in the rocker arm-type vibration generating device is perpendicular to the axis L1, and an amplitude of vibration reaches a maximum in a direction perpendicular to the axis L1; and the rocker arm-type vibration generating device is installed in the inner cavity when the axis L1 is parallel to a length direction of the cylindrical elastic massage sleeve 6, such that the vibration offset is more likely to cause periodic bending deformation of the cylindrical elastic massage sleeve 6. Additionally, when the vibration massage device is in use, the cylindrical elastic massage sleeve 6 is inserted into the target massage area, the target massage area wraps a circumferential wall surface of the cylindrical elastic massage sleeve 6, and therefore, the target massage area mainly receives the vibration in a direction of the maximum amplitude of vibration, thereby preventing numbness caused by the small-amplitude vibration.

In the description of the embodiments of the present disclosure, it needs to be understood that the orientation or positional relationships indicated by the terms “upper”, “lower”, “front”, “rear”, “left”, “right”, “vertical”, “horizontal”, “center”, “top”, “bottom”, “top portion”, “bottom portion”, “inner”, “outer”, “inner side”, “outer side” and the like are based on the orientation or positional relationship shown in the accompanying drawings, are merely for facilitating the description of the present disclosure and simplifying the description, rather than indicating or implying a device or element referred to must have a particular orientation or be constructed and operated in a particular orientation, and therefore will not be interpreted as limiting the present disclosure. The term “inner side” refers to an interior or an area or space enclosed, and the term “periphery” refers to an area around a specific component or a specific area.

In the description of the embodiments of the present disclosure, the terms “first”, “second”, “third”, and “fourth” are for descriptive purposes only and are not to be construed as indicating or implying their relative importance or implicitly specifying the number of indicated technical features. Thus, a feature defined with “first”, “second”, “third”, and “fourth” may explicitly or implicitly include one or more of the features. In the description of the present disclosure, “a plurality of” means two or more, unless otherwise specified.

In the description of the embodiments of the present disclosure, it should be noted that, unless otherwise explicitly specified and defined, the terms “mounting”, “connecting”, “connection” and “assembling” should be understood in a broad sense, for example, they may be a fixed connection, a detachable connection, or an integrated connection; and may be a direct connection, or an indirect connection via an intermediate medium, or communication inside two elements. For those of ordinary skill in the art, the specific meanings of the above terms in the present disclosure may be understood according to specific circumstances.

In the description of the embodiments of the present disclosure, specific features, structures, materials or characteristics described may be combined in a suitable manner in any one or more embodiments or embodiments.

In the description of the embodiments of the present disclosure, it should be understood that that “-” and “~” represent the same range of two numerical values, and the range includes end values thereof. For example, “A-B” means a range greater than or equaling to A and less than or equaling to B. “A~B” means a range greater than or equaling to A and less than or equaling to B.

In the description of the embodiments of the present disclosure, the term “and/or” represents merely an association relationship describing associated objects, indicating that there may be three types of relationships, for example, A and/or B, which means three types of situation, that is, the existence of A alone, the existence of both A and B, and the existence of B alone. In addition, the character “/” herein generally indicates that the associated objects are in an “or” relationship.

Although the embodiments of the present disclosure have been illustrated and described, it should be understood that those of ordinary skill in the art may make various changes, modifications, replacements and variations to the above embodiments without departing from the principle and spirit of the present disclosure, and the scope of the present disclosure is limited by the appended claims and their legal equivalents.

1. A rocker arm-type vibration generating device provided with a drive motor, comprising:
a rocker arm assembly provided with a driven portion, a driving portion, and a rocker arm joint;
a linkage assembly provided with a driving end and a responding end; and
a support assembly provided with a first end and a second end;
wherein the drive motor is connected to the driving end;
wherein the driven portion is connected to the responding end;
wherein the first end is connected to the rocker arm joint to support and form a fulcrum of the rocker arm assembly;
wherein an axis L1 extends from the second end to the first end, and an axis L2 extends from the rocker arm joint to the driving portion;
the axis L1 and the axis L2 are not parallel to each other;
wherein the linkage assembly is configured to convert a rotational motion of the driving end to a swinging and/or rotational motion of the axis L2 relative to the axis L1 in a linked manner;
wherein the first end is connected to a first vibration load; and/or
the second end is connected to a second vibration load; and/or
the driving portion is connected to a third vibration load; and
wherein the first end, the second end, and the driving portion are configured to transmit vibration energy outward.

2. The rocker arm-type vibration generating device according to claim 1, wherein
the third vibration load is a counterweight.

3. The rocker arm-type vibration generating device according to claim 1, wherein
the driving portion performs a circumferential rotational motion around the axis L1.

4. The rocker arm-type vibration generating device according to claim 1, wherein
the axis L2 performs a swinging motion with the rocker arm joint as a center of a circle.

5. The rocker arm-type vibration generating device according to claim 4, wherein
the rocker arm joint is provided with a first protrusion, the first protrusion forms a spherical structure, the first end is provided with a first connection hole, an axis of the first connection hole is collinear with the axis L1, and an inner wall surface of the first connection hole has a spherical structure; and
the spherical structure of the first protrusion, and the spherical structure of the first connection hole form a spherical fit.

6. The rocker arm-type vibration generating device according to claim 4, wherein
the first end is provided with a flexible cover plate, and the flexible cover plate is provided with a second connection hole;
the rocker arm joint is provided with two first axial limiting portions, and the two first axial limiting portions are respectively located at both ends of the flexible cover plate in a thickness direction, to restrict an axial displacement between the rocker arm assembly and the flexible cover plate; and
flexible deformation of the flexible cover plate permits swinging of the rocker arm assembly.

7. The rocker arm-type vibration generating device according to claim 4, wherein the first end is provided with a fourth connection hole, and an inner wall surface of the fourth connection hole and a circumferential wall surface of the rocker arm joint are provided with a second axial limiting portion and a fourth protrusion respectively, wherein two second axial limiting portions are arranged, and the two second axial limiting portions are respectively located on both sides of the fourth protrusion in a direction of the axis L1; and
the second axial limiting portions limit a sliding distance of the rocker arm assembly along the axis L1 and enable the rocker arm assembly to swing.

8. The rocker arm-type vibration generating device according to claim 4, wherein the support assembly has a cylindrical structure, the first end is one end of the cylindrical structure, and the first end is connected to the rocker arm assembly through a flexible strip; and
flexible deformation of the flexible strip permits swinging of the rocker arm assembly.

9. The rocker arm-type vibration generating device according to claim 1, wherein the driving portion performs an elliptical motion around the axis L1.

10. The rocker arm-type vibration generating device according to claim 9, wherein a waist-shaped hole is formed in the first end, and a length direction of the waist-shaped hole is perpendicular to the axis L1; and the rocker arm joint is provided with a second protrusion, and a circumferential wall surface of the second protrusion and an inner wall surface of the waist-shaped hole are provided with spherical surfaces coupled to each other.

11. The rocker arm-type vibration generating device according to claim 9, wherein the first end is provided with a first sliding groove, a sliding direction is perpendicular to the axis L1, and a first sliding block is installed in the first sliding groove; and
the rocker arm joint is connected to the first sliding block, and the first sliding block forms the fulcrum.

12. The rocker arm-type vibration generating device according to claim 11, wherein the rocker arm joint is provided with a third protrusion, the third protrusion forms a spherical structure, the first sliding block is provided with a third connection hole, an axis of the third connection hole is parallel to the axis L1, and an inner wall surface of the third connection hole has a spherical structure; and
the spherical structure of the third protrusion, and the spherical structure of the third connection hole form a spherical fit.

13. The rocker arm-type vibration generating device according to claim 3, wherein
the responding end abuts against the driven portion in a rotation direction, and the driven portion is pushed to move in a rotation direction of the drive motor;
the responding end rotates relative to the rocker arm assembly; and
the abutment of the responding end against the driven portion enables the rocker arm assembly to maintain a fixed swinging angle.

14. The rocker arm-type vibration generating device according to claim 1, wherein
the driving portion is provided with a protective sleeve; and
the protective sleeve is sleeved outside the driving portion to isolate the driving portion from a flexible layer of a massager; and
the protective sleeve freely rotates relative to the driving portion.

15. The rocker arm-type vibration generating device according to claim 1, wherein the support assembly is fixedly connected to the drive motor.

16. The rocker arm-type vibration generating device according to claim 1, wherein
the drive motor is flexibly connected to the driving end, and
is directly or indirectly flexibly connected to the support assembly.

17. The rocker arm-type vibration generating device according to claim 16, wherein the drive motor is flexibly connected to the support assembly through an elastic member, and the elastic member allows the support assembly to move relative to the drive motor; and
the elastic member supports the flexible layer of the massager.

18. The rocker arm-type vibration generating device according to claim 16, wherein the driving end is rotatably connected to the support assembly.

19. The rocker arm-type vibration generating device according to claim 1, wherein
an included angle between the axis L1 and the axis L2 is denoted as a, and a degree of the included angle a ranges from 5° to 30°.

20. A vibration massage device, comprising
the rocking arm-type vibration generating device according to claim 1; and further comprising
a cylindrical elastic massage sleeve provided with an inner cavity;
wherein the rocker arm-type vibration generating device is disposed in the inner cavity; and
wherein the swinging and/or rotational motion of the axis L2 relative to the axis L1 causes periodic bending deformation of the cylindrical elastic massage sleeve.
